(19) United States
(12) Patent Application Publication
(10) Pub. No.: US 2019/0075597 A1
(43) Pub. Date: Mar. 7, 2019

(54) METHODS, APPARATUSES AND SYSTEMS FOR SUPPORTING LONG TERM CHANNEL SENSING IN SHARED SPECTRUM

(71) Applicant: QUALCOMM Incorporated, San Diego, CA (US)

(72) Inventors: Srinivas YERRAMALLI, San Diego, CA (US); Tamer KADOUS, San Diego, CA (US)

(21) Appl. No.: 16/108,862

(22) Filed: Aug. 22, 2018

Related U.S. Application Data
(60) Provisional application No. 62/553,507, filed on Sep. 1, 2017.

(51) Int. Cl. H04W 74/08; H04W 72/04; H04W 36/04; H04J 11/00; H04W 8/22; H04L 5/00

(52) U.S. Cl. CPC H04W 74/0816; H04W 72/0446; H04W 36/04; H04W 16/14; H04W 8/22; H04L 5/0055; H04J 11/0073

(57) ABSTRACT

Methods, systems, and devices for wireless communication are described. A base station may configure a system frame number (SFN) and hyper-SFN associated with a long term sensing pattern. The base station may then transmit the SFN and hyper-SFN to indicate a sensing period corresponding to the long term sensing pattern. A UE may receive a SFN and hyper-SFN associated with a long term sensing pattern. The UE may determine, based on the SFN and hyper-SFN, a sensing period corresponding to the long term sensing pattern. The UE may then suspend a plurality of procedures during the sensing period.

### CROSS REFERENCE

The present Application for Patent claims priority to U.S. Provisional Application No. 62/553,507 by Srinivas Yerramalli et al., entitled “METHODS, APPARATUSES AND SYSTEMS FOR SUPPORTING LONG TERM CHANNEL SENSING IN SHARED SPECTRUM,” filed Sep. 1, 2017, which is assigned to the assignee hereof.

### BACKGROUND

The following relates generally to wireless communication, and more specifically to methods, apparatuses and systems for supporting long term channel sensing in a shared radio frequency spectrum (or shared spectrum).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

Some wireless communications systems may enable communication between a base station and a UE with long term channel sensing in a shared spectrum. The requirement for long term channel sensing may include performing channel sensing (sensing period) for a few hundred milliseconds or seconds to contend for the shared medium, and if successful, accessing the medium (transmission period) for several minutes or hours. Since the sensing period is very short compared to the transmission period, a system such as an LTE system may be deployed in such an environment. However, the sensing period is very large compared to the timing structure of the LTE system. Many procedures may not function properly if the base station goes away for even a few hundred milliseconds or seconds during the sensing period. Improved techniques for implementing long term channel sensing within an LTE system may thus be desired.

### SUMMARY

The described techniques relate to improved methods, systems, devices, and apparatuses that support long term channel sensing in shared spectrum. In an aspect, a method for wireless communication includes configuring a system frame number (SFN) and hyper-SFN associated with a long term sensing pattern, and transmitting the SFN and hyper-SFN to indicate a sensing period corresponding to the long term sensing pattern. In another aspect, a method for wireless communication includes receiving a system frame number (SFN) and hyper-SFN associated with a long term sensing pattern, determining, based on the SFN and hyper-SFN, a sensing period corresponding to the long term sensing pattern, and suspending a plurality of procedures during the sensing period.

In some other aspects, an apparatus for wireless communication includes a processor, memory in electronic communication with the processor, instructions stored in the memory, and transmitter. The instructions are executable by the processor to configure a system frame number (SFN) and hyper-SFN associated with a long term sensing pattern. The transmitter is configured to transmit the SFN and hyper-SFN to indicate a sensing period corresponding to the long term sensing pattern. In still other aspects, an apparatus for wireless communication includes a processor, memory in electronic communication with the processor, instructions stored in the memory, and receiver. The receiver is configured to receive a system frame number (SFN) and hyper-SFN associated with a long term sensing pattern. The instructions are executable by the processor to determine, based on the SFN and hyper-SFN, a sensing period corresponding to the long term sensing pattern, and to suspend a plurality of procedures during the sensing period.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

FIG. 1 illustrates an example of a system for wireless communication in accordance with aspects of the present disclosure.

FIG. 2 illustrates an example of a time division duplexing (TDD) system for deployment in a shared spectrum in accordance with aspects of the present disclosure.

FIG. 3 illustrates an example of a long term channel sensing pattern for use in a shared spectrum in accordance with aspects of the present disclosure.

FIGS. 4-7 illustrate block diagrams of methods for supporting long term channel sensing in a shared spectrum in accordance with aspects of the present disclosure.

FIG. 8 illustrates a block diagram of a device that supports long term channel sensing in a shared spectrum in accordance with aspects of the present disclosure.

FIG. 9 illustrates a block diagram a system including a base station that supports long term channel sensing in a shared spectrum in accordance with aspects of the present disclosure.

FIGS. 10-16 illustrate block diagrams of methods for supporting long term channel sensing in a shared spectrum in accordance with aspects of the present disclosure.

FIG. 17 illustrates a block diagram of a device that supports long term channel sensing in a shared spectrum in accordance with aspects of the present disclosure.

FIG. 18 illustrates a block diagram of a device that supports long term channel sensing in a shared spectrum in accordance with aspects of the present disclosure.

FIG. 19 illustrates a block diagram of a system including a UE that supports long term channel sensing in a shared spectrum in accordance with aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Aspects of the disclosure are initially described in the context of a wireless communications system. Examples of techniques for long term channel sensing are described herein. Aspects of the disclosure are further illustrated by and described with reference to apparatus diagrams, system diagrams, and flowcharts that support long term channel sensing in a shared spectrum.

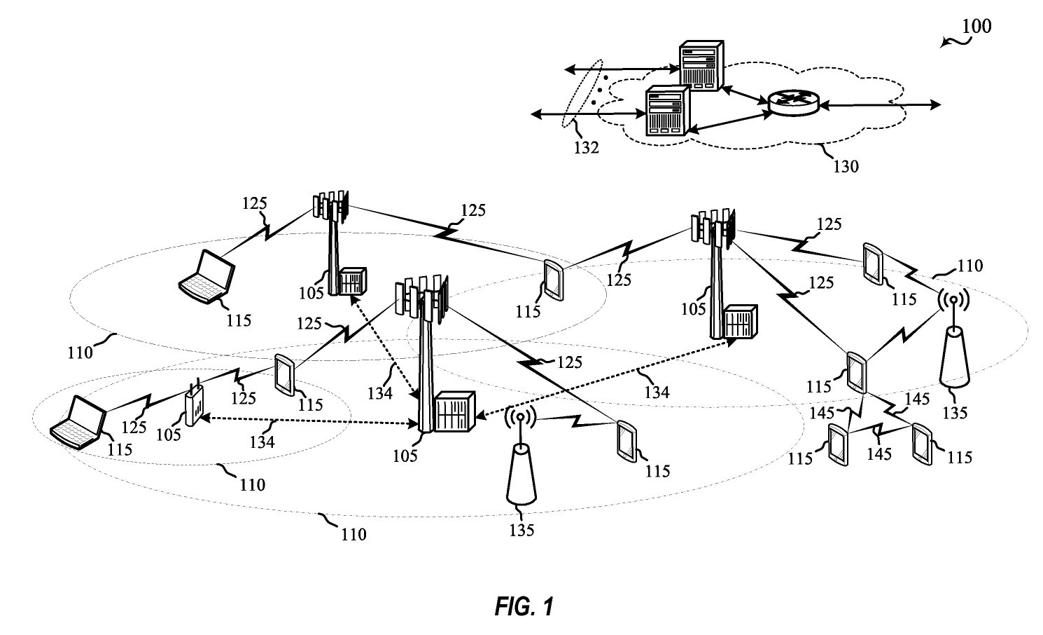

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, or a New Radio (NR) network. In some cases, wireless communications system 100 may support enhanced broadband communications, ultra-reliable (e.g., mission critical) communications, low latency communications, or communications with low-cost and low-complexity devices. Wireless communications system 100 may support long term channel sensing in a shared spectrum.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., MTC, narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. eMTC devices may build on MTC protocols and support lower bandwidths in the uplink or downlink, lower data rates, and reduced transmit power, culminating in significantly longer battery life (e.g., extending batter life for several years). References to an MTC may also refer to an eMTC configured device.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications 145 may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications 145 may utilize a one-to-many (1:M) system in which each UE 115 transmits to every other UE 115 in the group. In some cases, a base station 105 facilitates the scheduling of resources for D2D communications. In other cases, D2D communications 145 are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, the wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation (CA) configuration in conjunction with component carriers (CCs) operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, the base station 105 or UE 115 may be equipped with multiple antennas, which may be used to employ techniques such as transmit diversity, receive diversity, multiple-input multiple-output (MIMO) communications, or beamforming. For example, the wireless communication system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, the wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Media Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, the UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ= 1/30,720,000 seconds. Time intervals of a communications resource may be organized according to radio frames each having a duration of 10 milliseconds (ms), where the frame period may be expressed as T_{f}=307,200 T. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier.

In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or resource blocks (RBs)) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that can support simultaneous communications via carriers associated with more than one different carrier bandwidth.

The wireless communications system 100 may support communication with a UE 115 on multiple cells or carriers, a feature which may be referred to as CA or multi-carrier operation. A UE 115 may be configured with multiple downlink CCs and one or more uplink CCs according to a carrier aggregation configuration. Carrier aggregation may be used with both FDD and TDD component carriers.

In some cases, the wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by the UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

According to techniques described herein, wireless communications system 100 may support long term channel sensing in shared spectrum. The base station 105 may indicate a long term sensing pattern to the UE 115. The base station 105 may suspend all transmissions during a channel sensing period corresponding to the long term sensing period. Additionally, the UE 115 may suspend one or more procedures during the sensing period as well. However, the UE 115 may be configured to continue updates to other procedures during the sensing period. The base station 105 may resume transmissions after the sensing period if it is determined that the medium is available. Further, the UE 115 may resume operations after the sensing period if it has detected that the base station 105 has acquired the medium and restarted transmission. The techniques for supporting long term channel sensing in shared spectrum are described in more detail below.

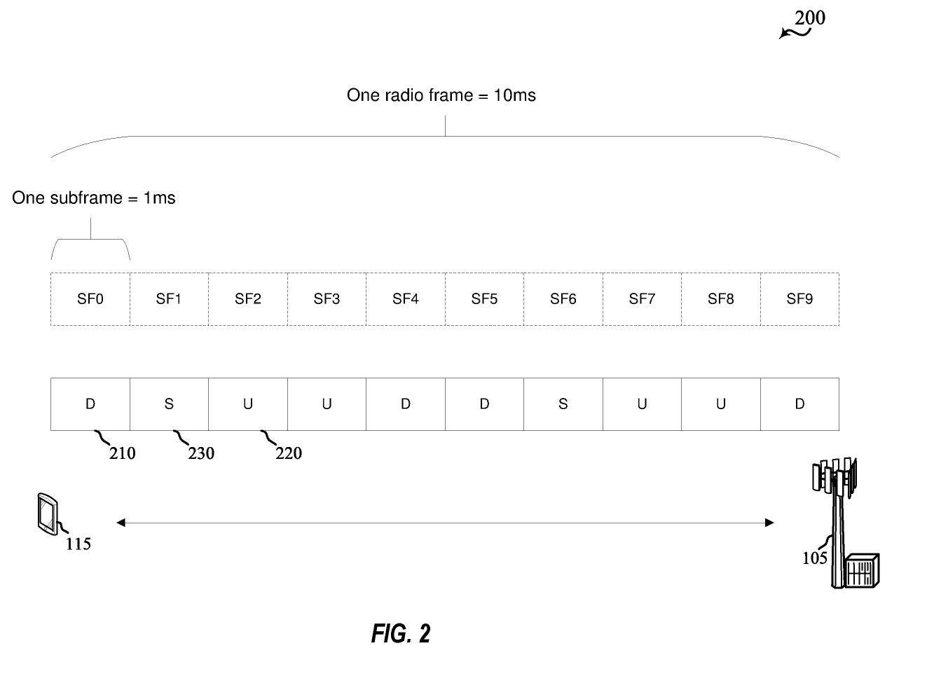

FIG. 2 illustrates an example of a time division duplexing (TDD) system 200 that may be deployed in a shared spectrum in accordance with various aspects of the present disclosure. In some examples, the TDD system 200 may include a base station 105 and UE 115, which may be examples of the corresponding devices as described with reference to FIG. 1. The TDD system 200 may implement an LTE TDD protocol. For example, LTE TDD may have a frame structure that may be organized according to radio frames each having a duration of 10 milliseconds (ms). The radio frame may be identified by a system frame number (SFN) ranging from 0 to 1023 (e.g., 10 bit SFN). Each radio frame may include 10 subframes numbered from SF0 to SF9, and each subframe may have a duration of 1 ms.

In LTE TDD, a radio frame may be configured with a number of TDD configurations (also referred to as downlink (DL)-uplink (UL) configuration). As shown here, some subframes 210 may be configured for downlink transmissions (D subframes—SF0, SF4, SF5, SF9) and some subframes 220 may be configured for uplink transmissions (U subframes—SF2, SF3, SF7, SF8). Further, there may be special subframes 230 (S subframes—SF1, SF6) where the switch between downlink and uplink occurs. It should be noted the description of the LTE TDD protocol herein is for simplicity sake, and that the LTE TDD protocol is described in detail in documents from 3GPP.

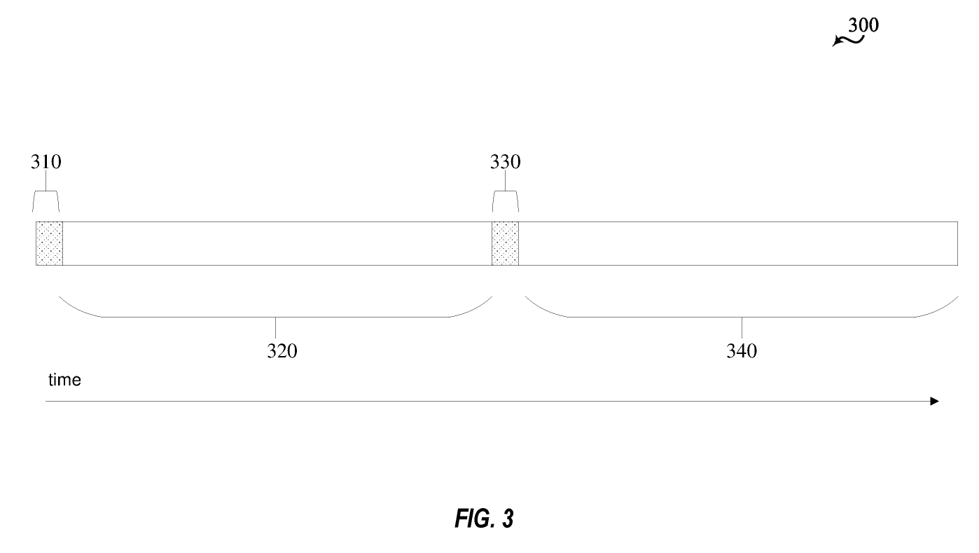

FIG. 3 illustrates an example of a long term sensing pattern 300 that may be implemented in a shared spectrum in accordance with various aspects of the present disclosure. In some examples, a UE 115 and base station 105 may operate in a shared spectrum (shared medium or shared channel or shared band), which may be licensed or unlicensed. In this regard, there may be coexistence mechanisms, such as listen before talk (LBT) or clear channel assessment (CCA) procedures, to ensure the spectrum is fairly shared with other users of the medium. Generally, there may be two types of medium-sensing procedures to contend for access to the shared spectrum. Short term LBT may be used where successful contention may result in medium access for a few ms (e.g., typically less than 10 ms). Short term LBT may have a channel sensing time on the order of a few hundred microseconds (μs) or a few ms. Examples of a system which uses short term LBT may include LAA, LTE-U, WiFi, and the like.

Long term LBT may be used where successful contention may result in medium access for several minutes or hours. Long term LBT may have a channel sensing time on the order of a few hundred ms or few seconds. In some examples, a shared eXtended Global Platform (sXGP) service may require use of long term LBT to operate in 1.9 GHz band, which may be shared with other services such as personal handy-phone system (PHS), digital enhanced cordless telecommunications (DECT), and the like. For example, the long term sensing pattern 300 may include a channel sensing period 310 followed by a transmission period 320 which may be repeated periodically with a next channel sensing period 330 followed by a next transmission period 340, etc.

During the channel sensing period 310,330, a device may perform an LBT or CCA procedure prior to communicating in order to determine whether the shared medium is available. In some examples, the device may perform energy detection to determine whether there are any other active transmissions. In other examples, the device may detect specific sequences (e.g., preamble, beacon, reservation signal, etc.) that indicate use of the medium. If successful (medium is available), the device may use the medium during the transmission period. If not successful (medium is unavailable), the device may not use the medium during the transmission period and waits until the next sensing period to contend for the medium.

For long term LBT, the channel sensing period 310,330 may be on the order of a few hundred ms and the transmission period 320,340 may be on the order of several minutes or hours. In this example, the long term sensing pattern implemented for sXGP service may be on the order of 300 ms for every hour of transmission. In other words, the duration of the sensing period (e.g., sensing period 310,330) may be 300 ms and the duration of the transmission period (e.g., transmission period 320,340) may be 1 hour. Thus, a device contending for the medium may measure the medium for about 300 ms, and if it detects energy in the medium, the device may not transmit on the medium for about one hour. Alternatively, if the device does not detect energy in the medium, the device may transmit on the medium for about one hour.

It has been contemplated about deploying a TDD system (such as the one 200 described with reference to FIG. 2) which implements long term channel sensing in shared spectrum (such as the one 300 described with reference to FIG. 3). In the example above, the long term channel sensing requires that a device perform channel sensing about once every hour. Accordingly, a fixed frame structure of LTE TDD may be sufficient since unavailability of the medium is less frequent as compared to short term LBT. However, even though the channel sensing period occurs less frequent in long term LBT, the duration of the sensing period is still very large relative to the timing of LTE frames (in ms). Various procedures may be adversely impacted if a base station goes silent for about few hundred ms to a second. For example, MAC and RCC timers may have expired, measurement-related procedures may be disrupted, radio link failure (RLF) may get triggered, and in general, the system may no longer operate in a proper manner.

Therefore, there is a need to inform the UEs of the sensing period and to modify various procedures to account for such interruption during the sensing period, which will be described in detail below. It should be noted that although a LTE TDD system is described above, the techniques for supporting long term channel sensing provided herein may also be applicable to a LTE FDD system or other systems which have similar timing characteristics.

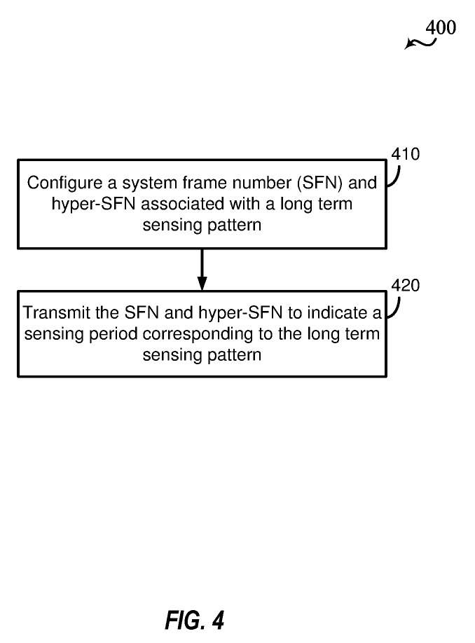

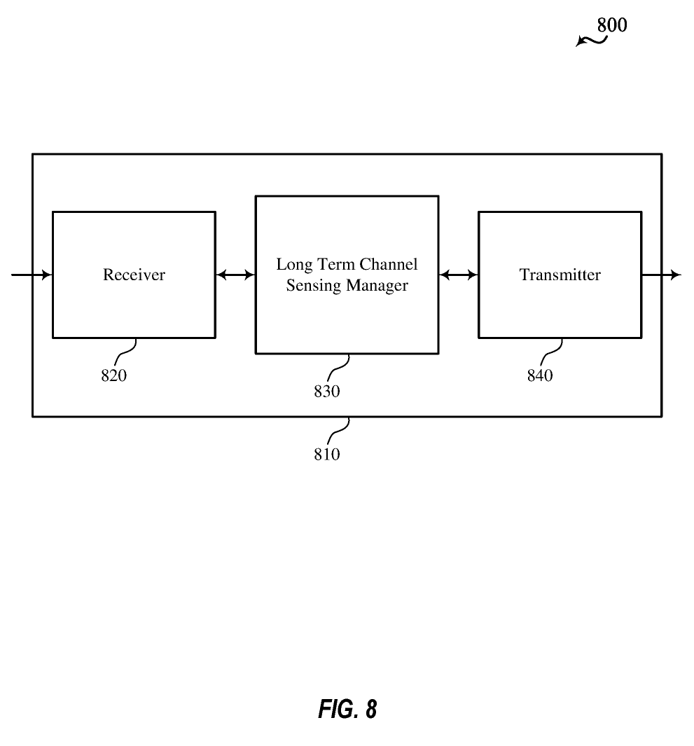

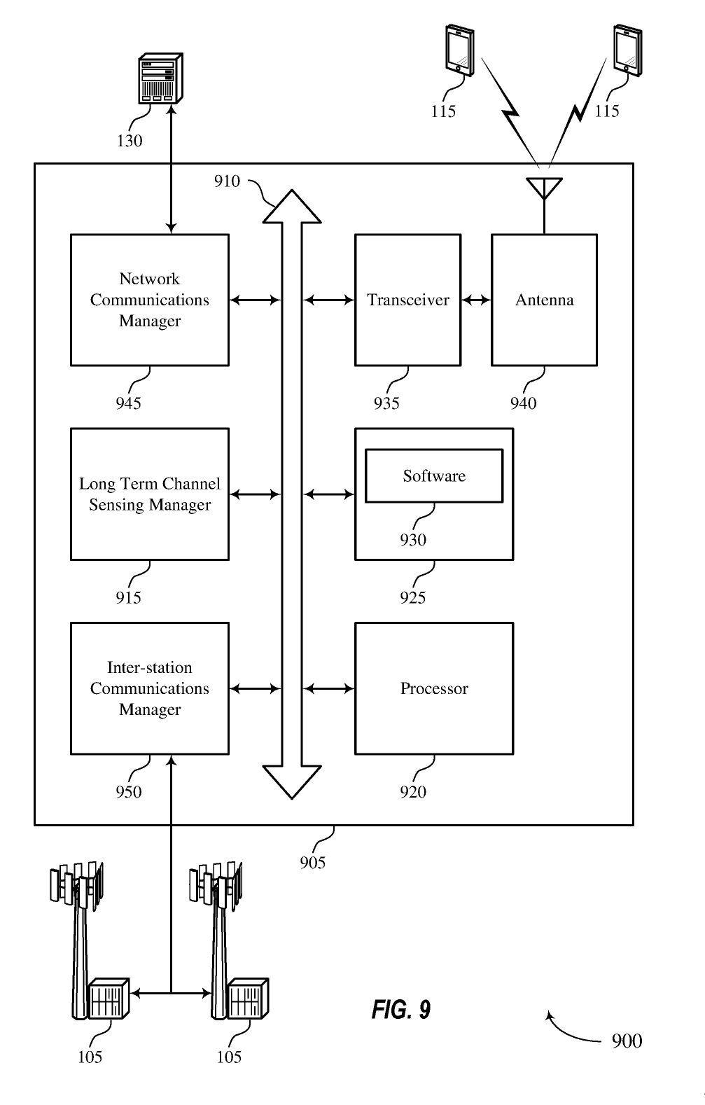

FIGS. 4-7 illustrate block diagrams of methods for supporting long term channel sensing in a shared spectrum in accordance with various aspects of the present disclosure. The operations of these methods may be implemented by a base station 105 or its components as described herein with reference to FIGS. 8-9. In some examples, a base station 105 may execute a set of codes to control the functional elements of the device to perform the functions described below. Additionally or alternatively, the base station 105 may perform aspects of the functions described below using special-purpose hardware.

In FIG. 4, a method 400 for supporting long term channel sensing in a shared spectrum is provided. At block 410, a base station 105 may configure a system frame number (SFN) and hyper-SFN associated with a long term sensing pattern. In some examples, a SFN may include a 10 bit SFN, and hyper-SFN may include a 10 bit hyper-SFN.

At block 420, the base station 105 may transmit the SFN and hyper-SFN to indicate a sensing period corresponding to the long term sensing pattern. In some examples, base station 105 may broadcasts the SFN and hyper-SFN to all UEs within its coverage area. In this regard, the SFN and hyper-SFN may be used to determine a periodicity and duration of the sensing period. In LTE, a 10 bit SFN may be used to identify an SFN ranging from 0-1023, which can address a radio frame that is within 10.24 seconds (10 ms×1024). This may be insufficient in a system implementing a long term sensing pattern since the time periods may be on the order of hours. Therefore, a 10 bit hyper-SFN may additionally be used along with the 10 bit SFN to address any radio frame that is within about 2.92 hours (10.24 s×1024). In some examples, the sensing period, such as the one 310,330 described with reference to FIG. 3, may be configured as a multiple of the number of radio frames (e.g., 10 radio frames (100 ms), 20 radio frames (200 ms), 30 radio frames (300 ms), etc.) for simplicity sake. In other examples, the sensing period may be configured as any duration in time.

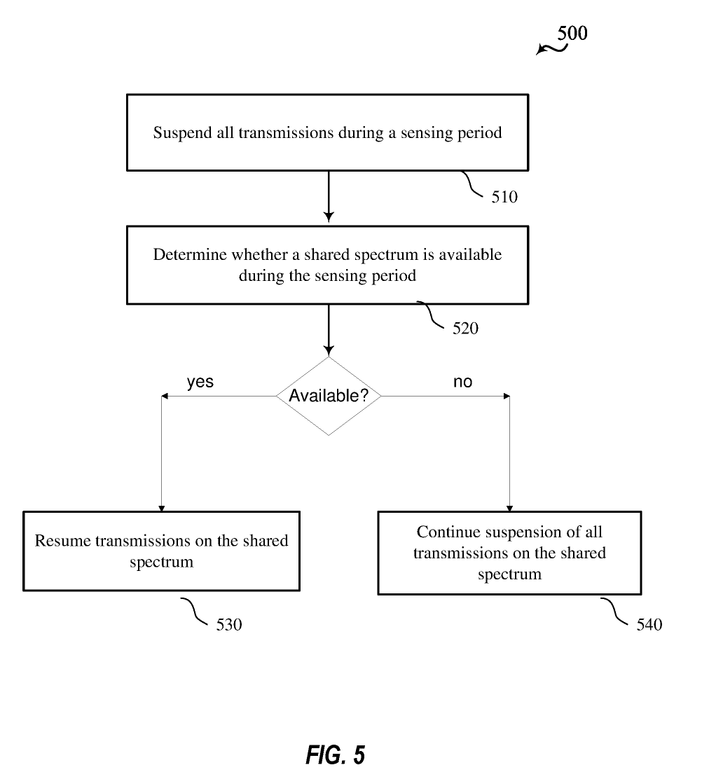

In FIG. 5, a method 500 for supporting long term channel sensing in a shared spectrum is provided. At block 510, a base station 105 may suspend all transmissions during a sensing period. The operations of block 510 may be performed according to the methods described herein. In some examples, the base station 105 does not transmit any downlink signals/channels (e.g., PSS/SSS, PBCH, PHICH, PDCCH, PDSCH, and the like) during the sensing period such as the one 310,330 described with reference to FIG. 3.

At block 520, the base station 105 may determine whether a shared spectrum is available during the sensing period. The operations of block 520 may be performed according to the methods described herein. In some examples, the base station 105 may perform energy detection during the sensing period to determine whether there are any other active transmissions.

At block 530, if it is determined that the shared spectrum is available, the base station 105 may resume transmissions after the sensing period. The operations of block 530 may be performed according to the methods described herein. In some examples, if the base station 105 detects no energy in the medium, the base station 105 may come back and resume operation (restart from suspended state) on the shared spectrum in a transmission period (such as the one 320,340 described with reference to FIG. 3.). In some examples, the base station 105 may communicate using LTE TDD protocol as was described with reference to FIG. 2.

At block 540, if it is determined that the shared spectrum is unavailable, the base station 105 may continue suspension of all transmission on the shared spectrum. The operations of block 540 may be performed according to the methods described herein. In some examples, if the base station 105 detects energy in the medium, the base station 105 may continue to suspend transmission of all downlink signals/channels during the transmission period and waits until the next opportunity to contend for the spectrum during the next sensing period.

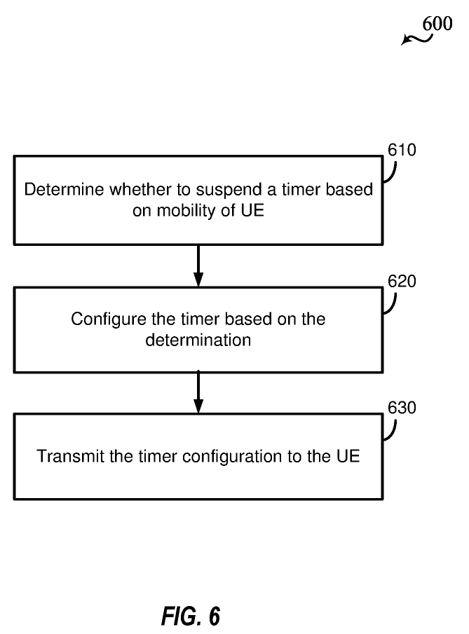

In FIG. 6, a method 600 for supporting long term channel sensing in a shared spectrum is provided. In some examples, a base station 105 may configure various MAC and RLC timers for a UE 115, which may be associated with various functions at the UE. For example, a plurality of timers may be associated with uplink timing alignment, discontinuous reception (DRX), HARQ retransmission, contention resolution, etc. The timers are described in more detail in documents from 3GPP.

At block 610, the base station 105 may determine whether to suspend a timer based on mobility of the UE. The operations of block 610 may be performed according to the methods described herein. In some examples, the base station 105 may configure, based on mobility of the UE, to suspend updating or to continue updating a timer during the sensing period. For example, it may be beneficial to configure an uplink timing alignment timer based on mobility of the UE. In some examples, the uplink timing alignment timer may be configured for a specific UE or group of UEs. In other examples, the uplink timing alignment timer may be configured for a specific cell.

The uplink timing alignment timer may be used for uplink synchronization to indicate whether the base station and UE are in sync in the uplink. The base station 105 may send a timing advance (TA) command to the UE, which may reset this timer when received by the UE. The uplink timing alignment timer may be counted down if the UE does not receive any TA commands from the base station. The UE may assume that it has lost uplink sync when the timer expires. As a result, the UE may flush all HARQ buffers and release PUCCH resources for SR and CQI, and SRS configurations.

At block 620, the base station 105 may configure a timer based on the determination made in block 610. The operations of block 620 may be performed according to the methods described herein. In some examples, the base station 105 may configure to suspend the uplink timing alignment timer during the sensing period for the UEs that are low mobility or stationary (e.g., IoT or MTC UEs). In this scenario, nothing will happen if the base station stops transmitting for a few hundred ms or a second during the sensing period. In other examples, the base station 105 may configure the uplink timing alignment with a very large number so it takes longer for this timer to expire for low mobility UEs. In still other examples, the base station 105 may configure to continue updating the uplink timing alignment timer during the sensing period for the UEs that are high mobility (fast moving UEs). In this scenario, uplink sync would most likely be lost by the time base station comes back on the medium after the sensing period. Thus, it may be appropriate for these UEs to perform RACH and connect to the same or different cell after the sensing period.

At block 630, the base station 105 may transmit the timer configuration to the UE. The operations of block 630 may be performed according to the methods described herein. In some examples, the base station may send timer configuration in an RRC message.

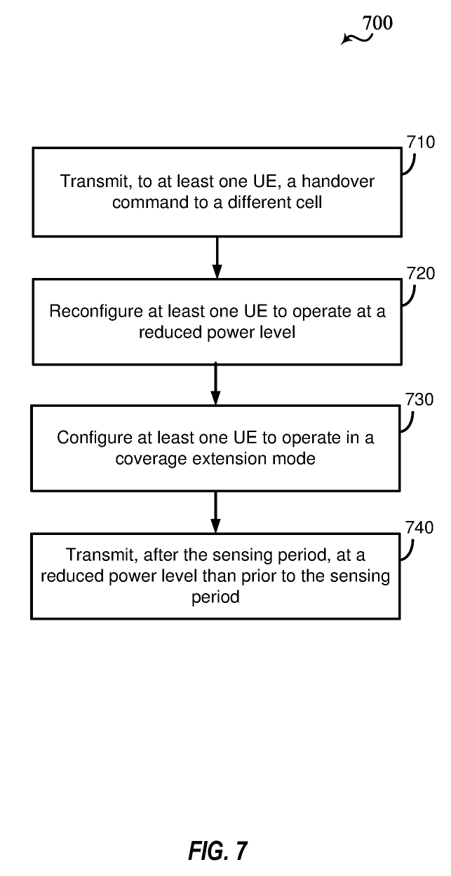

In FIG. 7, a method 700 for supporting long term channel sensing in a shared spectrum is provided. In some examples, a base station 105 may detect some energy in the medium during a sensing period but not enough to preclude all transmissions in a transmission period. For example, the base station may have detected other active transmissions that may be far away. In that regard, the base station may operate at a lower transmit power level and resume/restart transmissions on the shared medium in the transmission period. In some examples, the base station 105 may be allowed a predetermined time (grace period) before having to lower the transmit power level. The amount of transmit power variation may be up to 20 dB. It should be noted that this amount of power variation may be significant in terms of cell coverage, and that it may be challenging to modify the system to handle such power variation. The following are some options that the base station may perform in such a scenario.

At block 710, the base station 105 may transmit, to at least one UE, a handover command to a different cell. The operations of block 710 may be performed according to the methods described herein. In some examples, the base station 105 may transmit a handover command to perform handover to a different cell for some of its UEs.

At block 720, the base station 105 may reconfigure at least one UE to operate at a reduced power level. The operations of block 720 may be performed according to the methods described herein. In some examples, the base station 105 may send an RRC reconfiguration message to operate at a lower power level for some of its UEs. The RRC reconfiguration message may indicate that base station will operate at a lower power from this time onwards or after a certain duration (in ms or seconds).

At block 730, the base station 105 may configure at least one UE to operate in a coverage extension mode. The operations of block 730 may be performed according to the methods described herein. In some examples, the base station 105 may send an RRC configuration message to operate in a coverage extension mode for some of its UEs. For example, base station may support coverage extension (for eMTC or NB-IoT) as described in documents from 3GPP. In that regard, base station may configure some of its regular broadband UEs in this mode so that service may continue.

At block 740, the base station 105 may transmit, after the sensing period, at a reduced power level than prior to the sensing period. The operations of block 740 may be performed according to the methods described herein. The base station 105 may transmit at a power level that is less than a transmission power level used prior to the sensing period.

In some examples, it is understood that there may be scenarios where the base station may be required to immediately transmit at a lower power level after the sensing period has completed. In that regard, the base station may not have time to notify its UEs about the reduction in transmit power. Thus, the UEs may be forced to transition to RRC idle mode, and whichever of those UEs can connect back to the cell will do so with different parameters (e.g., measurement and connection parameters) to facilitate operating at a reduced power level.

FIG. 8 shows a block diagram 800 of a wireless device 810 that supports long term channel sensing in a shared spectrum in accordance with aspects of the present disclosure. The wireless device 810 may be an example of aspects of a base station 105 as described herein. The wireless device 810 may include a receiver 820, long term channel sensing manager 830, and transmitter 840. The wireless device 810 may also include a processor. Each of these components may be in communication with one another (e.g., via one or more buses).

The receiver 820 may receive information such as packets, user data, or control information associated with various uplink channels such as PUCCH, PUSCH, PRACH, sounding reference signal (SRS), scheduling request (SR). Information may be passed on to other components of the device. The receiver 820 may be an example of aspects of the transceiver 935 described with reference to FIG. 9. The receiver 820 may utilize a single antenna or a set of antennas.

The long term channel sensing manager 830 may be an example of aspects of a long term channel sensing manager 915 described with reference to FIG. 9.

The long term channel sensing manager 830 and/or at least some of its various sub-components may be implemented in hardware, software executed by a processor, firmware, or any combination thereof. If implemented in software executed by a processor, the functions of the long term channel sensing manager 830 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The long term channel sensing manager 830 and/or at least some of its various sub-components may be physically located at various positions, including being distributed such that portions of functions are implemented at different physical locations by one or more physical devices. In some examples, the long term channel sensing manager 830 and/or at least some of its various sub-components may be a separate and distinct component in accordance with various aspects of the present disclosure. In other examples, the long term channel sensing manager 830 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The long term channel sensing manager 830 may configure one or more parameters associated with a long term channel sensing pattern, and may manage operations during a sensing and transmission period corresponding to the long term channel sensing pattern. In some examples, the long term channel sensing manager 830 may configure a SFN and hyper-SFN to indicate a periodicity and duration of a sensing period corresponding to the long term channel sensing pattern. In other examples, the long term channel sensing manager 830 may suspend all transmissions during the sensing period. In still other examples, the long term channel sensing manager 830 may configure whether to suspend a timer based on mobility of UE. In some other examples, the long term channel sensing manager 830 may reduce a transmit power level after a sensing period.

The transmitter 840 may transmit signals generated by other components of the device. In some examples, the transmitter 840 may be collocated with a receiver 820 in a transceiver module. For example, the transmitter 840 may be an example of aspects of the transceiver 935 described with reference to FIG. 9. The transmitter 840 may utilize a single antenna or a set of antennas.

The transmitter 840 may transmit the SFN and hyper-SFN to indicate a sensing period corresponding to the long term sensing pattern. In some examples, the transmitter 840 may transmit at a reduced power level after the sensing pattern. In some other examples, the transmitter may transmit a handover command to a different cell, or may transmit a reconfiguration to operate at a lower power level, or may transmit a configuration to operate in a coverage extension mode.

FIG. 9 shows a diagram of a system 900 including a device 905 that supports long term sensing in a shared spectrum in accordance with aspects of the present disclosure. The device 905 may be an example of or include the components of wireless device 810, or a base station 105 as described herein. The device 905 may include components for bi-directional voice and data communications including components for transmitting and receiving communications, including a long term channel sensing manager 915, processor 920, memory 925, software 930, transceiver 935, antenna 940, network communications manager 945, and inter-station communications manager 950. These components may be in electronic communication via one or more buses (e.g., bus 910). The device 905 may communicate wirelessly with one or more user equipment (UE)s 115.

The processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 920 may be configured to operate a memory array using a memory controller. In other cases, a memory controller may be integrated into the processor 920. The processor 920 may be configured to execute computer-readable instructions stored in a memory to perform various functions (e.g., functions or tasks supporting long term channel sensing in a shared spectrum).

The memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

The software 930 may include code to implement aspects of the present disclosure, including code to support long term channel sensing in a shared spectrum. The software 930 may be stored in a non-transitory computer-readable medium such as system memory or other memory. In some cases, the software 930 may not be directly executable by the processor but may cause a computer (e.g., when compiled and executed) to perform functions described herein.

The transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the device 905 may include a single antenna 940. However, in some cases the device 905 may have more than one antenna 940, which may be capable of concurrently transmitting or receiving multiple wireless transmissions.

The network communications manager 945 may manage communications with the core network (e.g., via one or more wired backhaul links). For example, the network communications manager 945 may manage the transfer of data communications for client devices, such as one or more UEs 115.

The inter-station communications manager 950 may manage communications with other base stations 105, and may include a controller or scheduler for controlling communications with UEs 115 in cooperation with other base stations 105. For example, the inter-station communications manager 950 may coordinate scheduling for transmissions to UEs 115 for various interference mitigation techniques such as beamforming or joint transmission. In some examples, the inter-station communications manager 950 may provide an X2 interface within an Long Term Evolution (LTE)/LTE-A wireless communication network technology to provide communication between base stations 105.

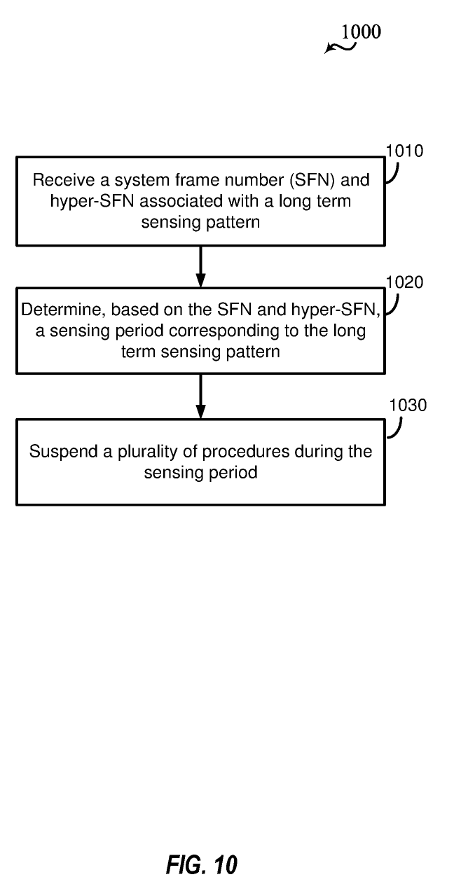

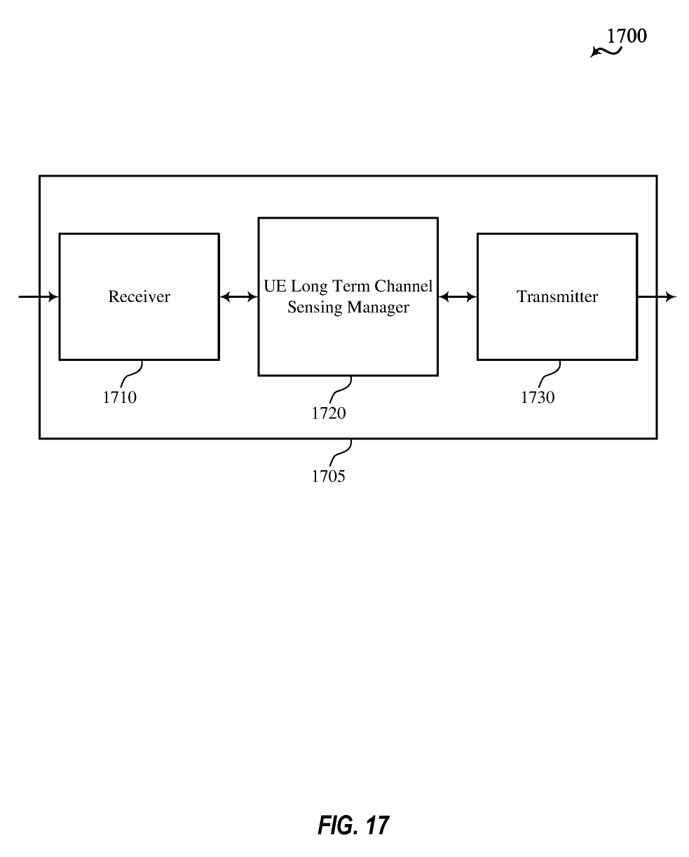

FIGS. 10-16 illustrate block diagrams of various methods for supporting long term channel sensing in a shared spectrum in accordance with aspects of the present disclosure. The operations of these methods may be implemented by a UE 115 or its components as described herein with reference to FIGS. 17-19. In some examples, a UE 115 may execute a set of codes to control the functional elements of the device to perform the functions described below. Additionally or alternatively, the UE 115 may perform aspects of the functions described below using special-purpose hardware.

In FIG. 10, a method 1000 for supporting long term sensing in a shared spectrum is provided. At block 1010, a UE 115 may receive a system frame number (SFN) and hyper-SFN associated with a long term sensing pattern. The operations of block 1010 may be performed according to the methods described herein. In some examples, the UE 115 may receive a 10 bit SFN and 10 bit hyper SFN in system information carried on PBCH.

At block 1020, the UE 115 may determine, based on the SFN and hyper-SFN, a sensing period corresponding to the long term sensing pattern. The operations of block 1020 may be performed according to the methods described herein. In some examples, the UE may use the 10 bit SFN along with the 10 bit hyper-SFN to determine a periodicity and duration of a channel sensing period of the long term sensing pattern as was similarly described in FIG. 4.

At block 1030, the UE 115 may suspend a plurality of procedures during the sensing period. The operations of block 1110 may be performed according to the methods described herein. In some examples, the UE 115 may be aware that the base station 105 will suspend downlink transmission during the sensing period, and thus, the UE may suspend a plurality of procedures as will be described in detail below.

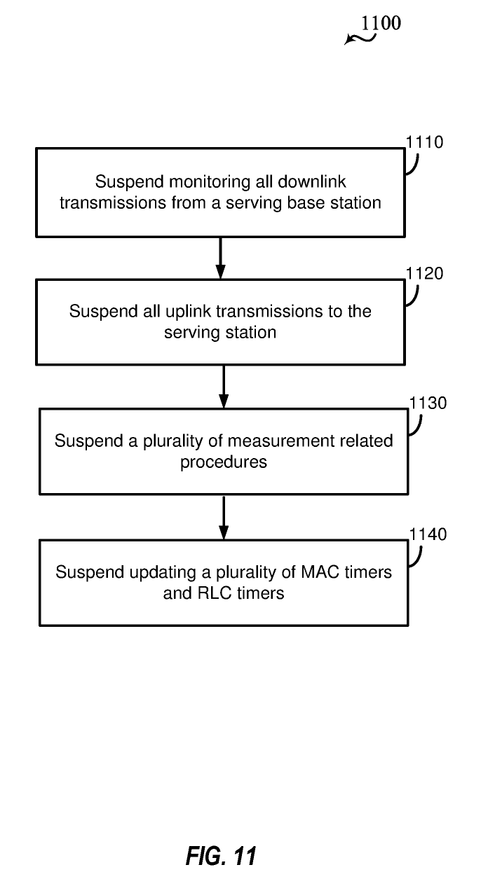

In FIG. 11, a method 1100 for supporting long term sensing in a shared spectrum is provided. In some examples, a UE 115 may be in connected mode (e.g., RRC connected mode) in which the UE is connected to the cell. In connected mode, the UE may be actively transmitting and receiving data, may be in a connected mode DRX, etc. If the UE functioned under normal operation, the UE may realize that base station has stopped transmitting or disappeared for some reason, and thus radio link management (RLM) may get triggered. After a while, radio link failure (RLF) would be declared. As such, by the time the base station comes back on the medium, the UE may most likely be in an RLF state and may attempt to reconnect to the cell. In order to prevent this behavior, the UE may suspend various procedures during the sensing period, and thus everything is basically in a suspended or frozen state. When the base station comes back on the medium after the sensing period, the UE may start again from that suspended state and resume normal operation.

At block 1110, the UE 115 may suspend monitoring all downlink transmissions from a serving base station. The operations of block 1110 may be performed according to the methods described herein. In some examples, the UE 115 suspend monitoring of all downlink transmissions such as PSS/SSS, PBCH, PHICH, PDCCH, PDSCH, and the like.

At block 1120, the UE 115 may suspend all uplink transmission to the serving base station. The operations of block 1120 may be performed according to the methods described herein. In some examples, the UE 115 may not transmit any uplink signals/channels such as PUCCH, PUSCH, PRACH, SRS, SR, and the like.

At block 1130, the UE 115 may suspend a plurality of measurement related procedures. The operations of block 1130 may be performed according to the methods described herein. In some examples, the UE 115 may suspend a plurality of measurement related procedures such as radio resource management (RRM), radio link management (RLM), and the like.

At block 1140, the UE 115 may suspend updating a plurality of MAC and RLC timers. The operations of block 1140 may be performed according to the methods described herein. In some examples, the UE 115 may suspend updating various timer such as DRX timer, HARQ retransmission timer, uplink timing alignment timer, etc.

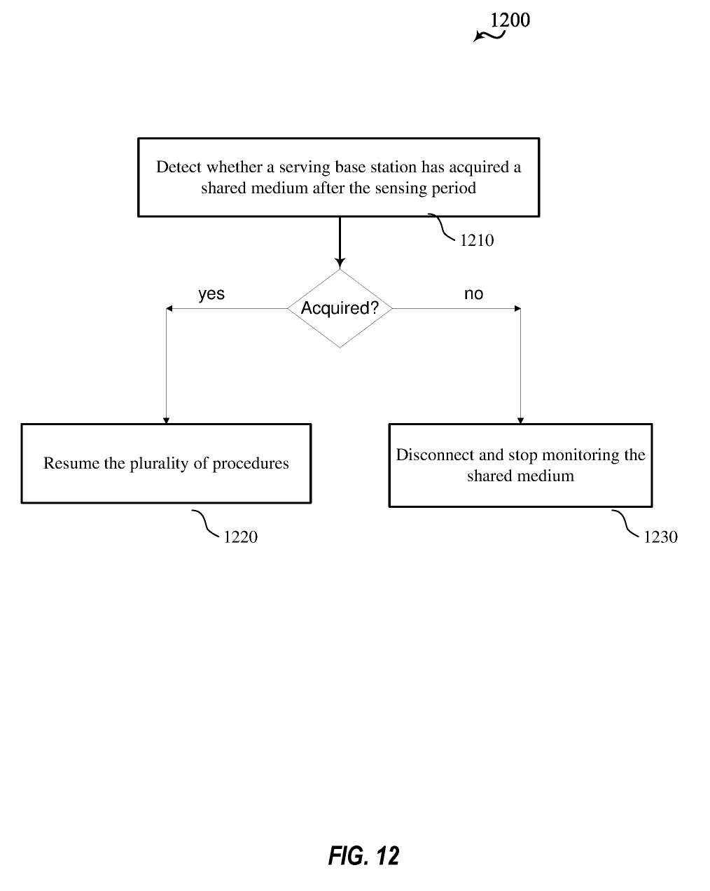

In FIG. 12, a method 1200 for supporting long term channel sensing in a shared spectrum is provided. As noted above, a UE 115 in connected mode may suspend various procedures during the sensing period. When a base station comes back on the medium after the sensing period, the UE 115 may start again from the suspended state and resume normal operation.

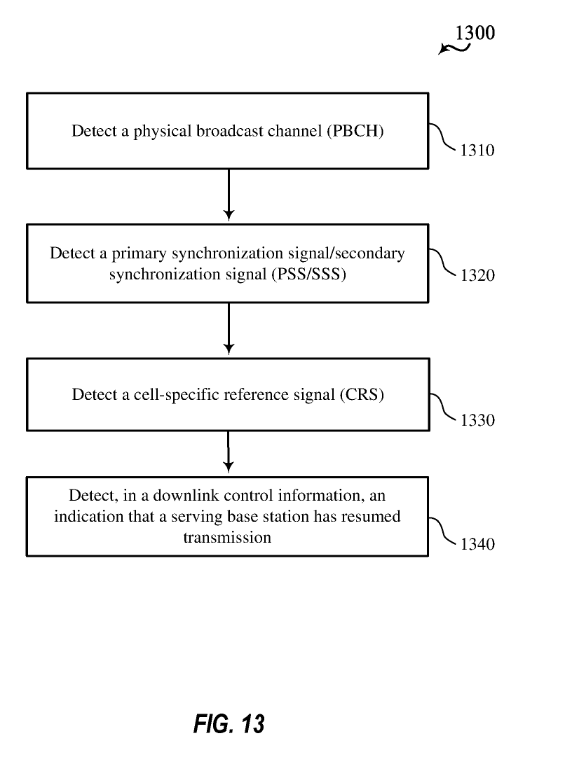

At block 1210, the UE 115 may detect whether a serving base station has acquired a shared medium after the sensing period. The operations of block 1210 may be performed according to the methods described herein. The UE 115 may detect that the base has resumed transmission as will be described in detail in FIG. 13.

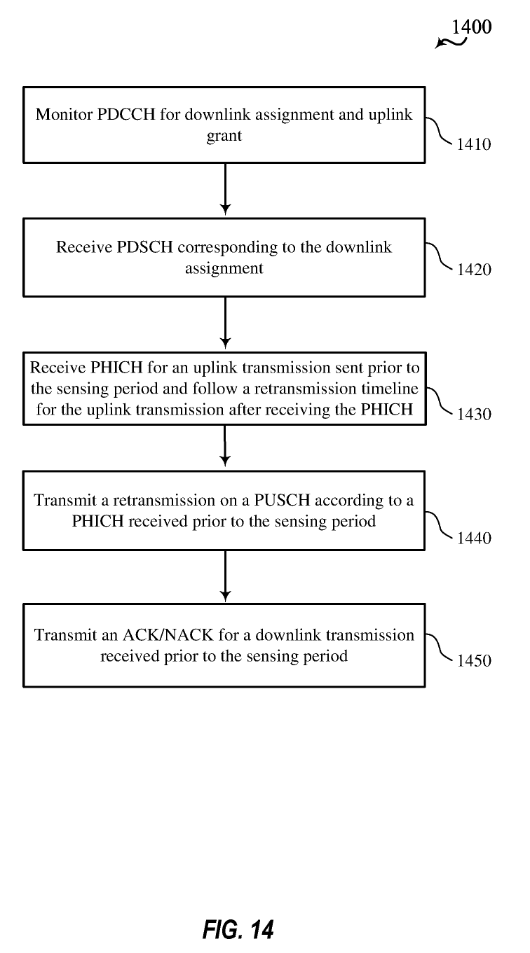

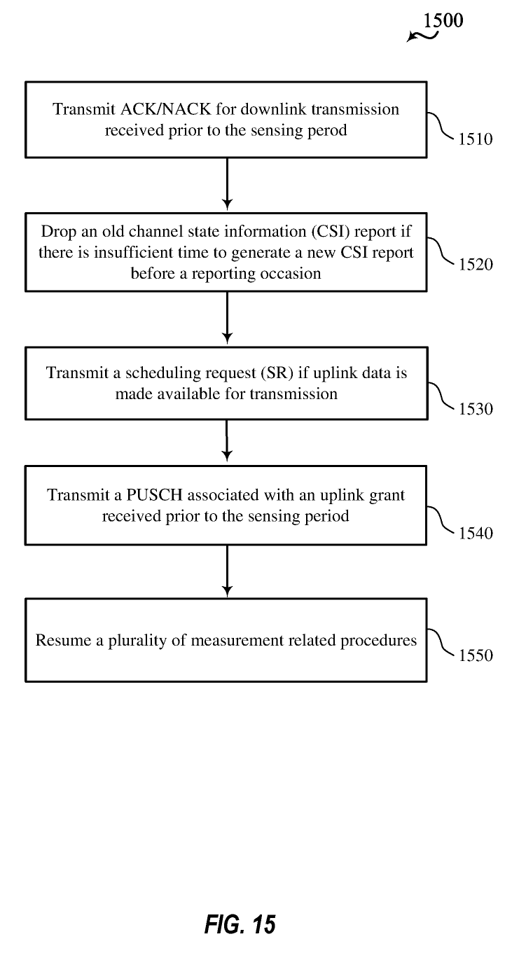

At block 1220, if the UE 115 has detected that the serving base station has acquired the shared spectrum, the UE 115 may resume the plurality of procedures. The operations of block 1220 may be performed according to the methods described herein. In some examples, the UE 115 may resume various procedures as will be described in detail in FIGS. 14 and 15.

At block 1230, if the UE 115 has detected that the serving base station has not acquired the shared spectrum, the UE 115 may disconnect and stop monitoring the shared spectrum. The operations of block 1230 may be performed according to the methods described herein.

In FIG. 13, a method 1300 for supporting long term channel sensing in a shared spectrum is provided. In some examples, a UE 115 may resume operation after the sensing period if it is determined that base station has come back on the medium, and restarted transmissions. The following are some options that the UE may use to detect that base station has acquired the shared medium after the sensing period. It should be noted that it is assumed that a base station starts transmission in subframe 0 (e.g., SF0) as defined in LTE protocol.

At block 1310, the UE 115 may detect a physical broadcast channel (PBCH). The operations of block 1310 may be performed according to the methods described herein. In some examples, the UE 115 may detect PBCH which is always transmitted in SF0.

At block 1320, the UE 115 may detect a primary synchronization signal/secondary synchronization signal (PSS/SSS). The operations of block 1320 may be performed according to the methods described herein. In some examples, the UE 115 may detect discovery reference signals such as PSS/SSS which are transmitted in SF0 and SF5.

At block 1330, the UE 115 may detect a cell-specific reference signal (CRS). The operations of block 1330 may be performed according to the methods described herein. In some examples, the UE 115 may perform CRS-based detection, which is transmitted in all subframes. In other examples, the UE 115 may use CRS to help validate PBCH or PSS/SSS detection.

At block 1340, the UE 115 may detect, in a downlink control information (DCI), an indication that a serving base station has restarted transmission. The operations of block 1340 may be performed according to the methods described herein. In some examples, the UE 115 may detect a DCI in a common search space of PDCCH, which announces that the base station has restarted transmission.

In FIG. 14, a method 1400 for supporting long term channel sensing in a shared spectrum is provided. In some examples, a UE 115 may have detected that a base station has acquired the shared spectrum and resumed operation in the transmission period. The UE may be in a connected mode prior to the sensing period.

At block 1410, the UE 115 may monitor for downlink assignment and uplink grant. The operations of block 1410 may be performed according to the methods described herein. In some examples, the UE 115 may again continue to monitor PDCCH for downlink assignment and uplink grants carried on PDCCH.

At block 1420, the UE 115 may receive PDSCH corresponding to the downlink assignment. The operations of block 1420 may be performed according to the methods described herein. In some examples, the UE 115 may receive PDSCH corresponding to the downlink assignment in PDCCH.

At block 1430, the UE 115 may receive PHICH for an uplink transmission sent prior to the sensing period, and may follow a retransmission timeline for the uplink transmission after receiving the PHICH. The operations of block 1430 may be performed according to the methods described herein. In some examples, the UE 115 may have transmitted an uplink transmission prior to the sensing period (e.g., just before base station went into sensing period). After the sensing period, the UE may receive an ACK/NACK in a PHICH transmission from the base station. The UE can maintain a retransmission timeline for that uplink transmission after receiving the PHICH. In other words, the UE may basically ignore the sensing period and may follow the timeline when PHICH is received after the sensing period. Thus, the base station may be able to keep service continuity even with the long interruption.

At block 1440, the UE 115 may transmit a retransmission on a PUSCH according to a PHICH received prior to the sensing period. The operations of block 1440 may be performed according to the methods described herein. In some examples, the UE 115 may receive an NACK in PHICH prior to the sensing period. The UE may retransmit on PUSCH and follow the timeline in the transmission period when the base station comes back on the medium.

At block 1450, the UE 115 may transmit ACK/NACK for a downlink transmission received prior to the sensing period. The operations of block 1450 may be performed according to the methods described herein. In some examples, the UE 115 may have received a downlink transmission and may still be processing it when the base station went into the sensing period. The UE may send the ACK/NACK after the base station comes back on the medium.

In FIG. 15, a method 1500 for supporting long term channel sensing in a shared spectrum is provided. In some examples, a UE 115 may have detected that a base station has acquired the shared spectrum and resumed operation in the transmission period. The UE 115 may be in a connected mode and an uplink timing alignment timer has not expired.

At block 1510, the UE 115 may transmit ACK/NACK for downlink transmission received prior to the sensing period. The operations of block 1510 may be performed according to the methods described herein. In some examples, the UE 115 may have received a downlink transmission and may still be processing it when the base station went into the sensing period. The UE may send the ACK/NACK after the base station comes back on the medium.

At block 1520, The UE 115 may drop an old channel state information (CSI) report if there is sufficient time to generate a new CSI report before a reporting occasion. The operations of block 1520 may be performed according to the methods described herein. In some examples, The UE 115 may drop the old CSI report (CSI report generated prior to the sensing period) and the UE does not have sufficient time to generate a new CSI report before the reporting occasion. Dropping the report may be appropriate since it may be inaccurate or stale by the time the UE comes back to the medium. In other examples, the UE may send the old report to the base station, and the base station may determine what to do with the report. In some other examples, the CSI-reporting may be periodic or aperiodic. The UE may receive a trigger to report CSI (e.g., aperiodic CSI report) just prior to the sensing period. The UE may have to wait until base station comes back to the medium, and may decide to drop the CSI report or to transmit old CSI report.

At block 1530, the UE 115 may transmit a scheduling request (SR) if uplink data is made available for transmission. The operations of block 1530 may be performed according to the methods described herein. In some examples, the UE 115 may determine that new uplink data has been made available for transmission during the sensing period. The UE may hold onto the SR and waits until the base station comes back to the medium, and then may transmit SR.

At block 1540, the UE 115 may transmit PUSCH associated with an uplink grant received prior to the sensing period. The operations of block 1540 may be performed according to the methods described herein. In some examples, the UE 115 may receive an uplink grant in PDCCH prior to the sensing period. The UE may wait until base station comes back to the medium and transmits PUSCH according the uplink grant. It is noted that a similar procedure may be performed for SRS triggered as part of PUSCH.

At block 1550, the UE 115 may resume a plurality of measurement related procedures. The operations of block 1550 may be performed according to the methods described herein. The UE 115 may resume RRM procedure, RLM procedure, and the like.

It should be noted that the various techniques described above with reference to FIG. 15 assumes that the uplink timing alignment timer has not expired (in sync on the uplink). Alternatively, if the uplink timing alignment timer has expired (out of sync on the uplink), the UE 115 may follow normal procedure in which there may be downlink data arrival from the base station side, the UE may expect a PDCCH order grant for non-contention based RACH resources so it may connect to the cell. In other examples, if uplink data is made available for transmission, the UE 115 may follow normal procedure to perform contention based random access to connect to the cell. In other examples, if the base station is also unsuccessful at contenting for the medium during the sensing period and disappears in the transmission period, RLF may be triggered at the UE, and thus, the UE may perform cell reselection according to normal procedures.

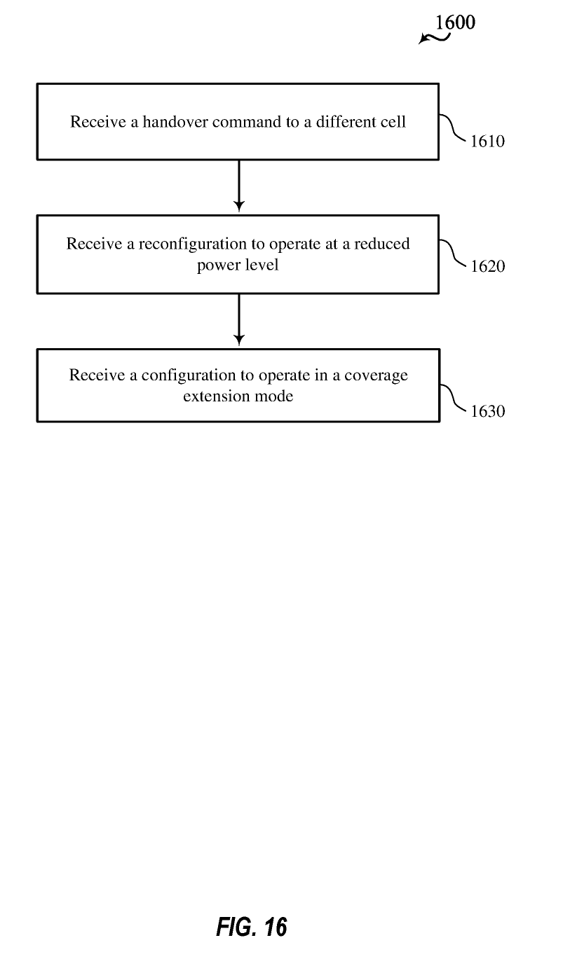

In FIG. 16, a method 1600 for supporting long term channel sensing in a shared spectrum is provided. In some examples, a UE may receive downlink transmission that were transmitted at a reduced power level as was described with reference to FIG. 7. The UE may be notified by base station in various ways to facilitate continued service as described below.

At block 1610, the UE 115 may receive a handover command to a different cell. The operations of block 1610 may be performed according to the methods described herein. In some examples, the UE 115 may receive a handover command to perform handover to a different cell.

At block 1620, the UE 115 may receive a reconfiguration to operate at a reduced power level. The operations of block 1620 may be performed according to the methods described herein. In some examples, the UE 115 may receive an RRC reconfiguration message to operate at a lower power level. The RRC reconfiguration message may indicate that base station will operate at a lower power from this time onwards or after a certain duration (in ms or seconds).

At block 1630, the UE 115 may receive a configuration to operate in a coverage extension mode. The operations of block 1630 may be performed according to the methods described herein. In some examples, the UE 115 may receive a RRC configuration message to operate in a coverage extension mode. For example, the UE may support coverage extension (for eMTC or NB-IoT) as described in documents from 3GPP.

In some examples, it is understood that there may be scenarios where the base station may be required to immediately transmit at a lower power level after the sensing period has completed. In that regard, the base station may not have time to notify its UEs about the reduction in transmit power. Thus, the UE 115 may be forced to transition to RRC idle mode, and if it can connect back to the cell it will do so with different parameters (e.g., measurement and connection parameters) to facilitate operating at a reduced power level.

It should be noted that a UE in idle mode (UE not connected to cell) may still be aware of the long term sensing period and base station will suspend transmission during the sensing period. In that regard, the UE's paging interval may fall into this sensing period. In some examples, the UE 115 may skip that paging occasion which occurred during the sensing period and look for the next possible paging occasion of the base station during the transmission period. The base station 105 may transmit paging messages (that were buffered prior to the sensing period) after it has come back onto the medium. In other examples, the UE 115 may wake up and may look for its paging occasion within a predetermined number of subframes.

FIG. 17 shows a block diagram 1700 of a wireless device 1705 that supports long term channel sensing in a shared spectrum in accordance with aspects of the present disclosure. The wireless device 1705 may be an example of aspects of a UE 115 as described herein. The wireless device 1705 may include a receiver 1710, UE long term channel sensing manager 1720, and transmitter 1730. The wireless device 1705 may also include a processor. Each of these components may be in communication with one another (e.g., via one or more buses).

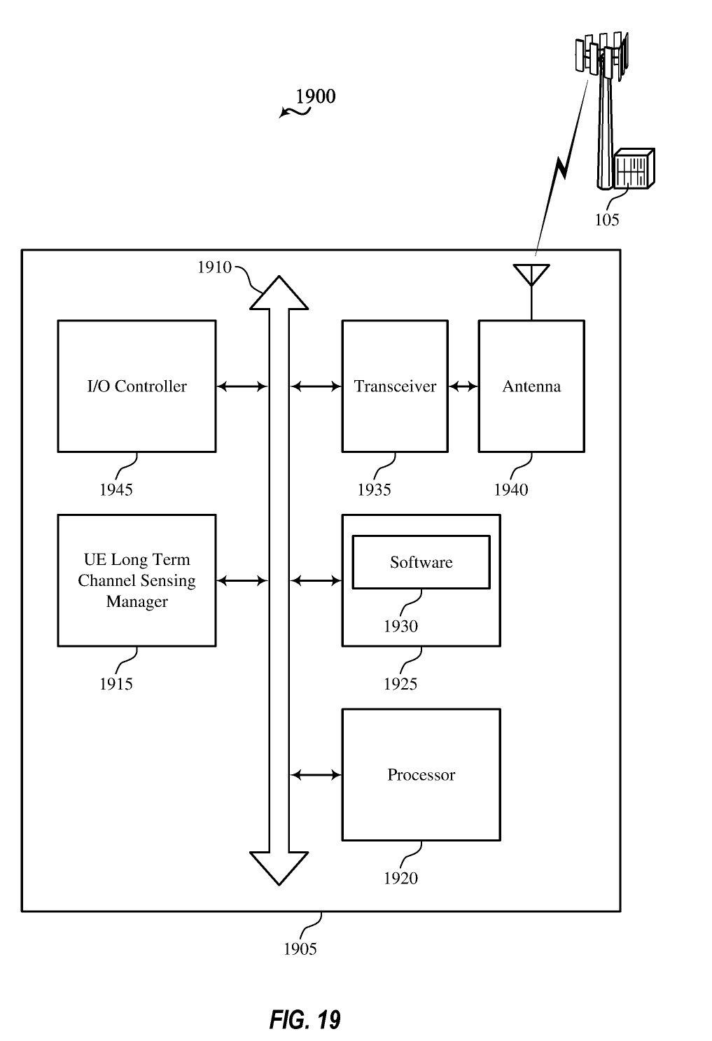

The receiver 1710 may receive information such as packets, user data, or control information associated downlink signals/channels such as PSS/SSS, PBCH, PHICH, PDCCH, PDSCH, and the like. Information may be passed on to other components of the device. The receiver 1710 may be an example of aspects of the transceiver 1935 described with reference to FIG. 19. The receiver 1710 may utilize a single antenna or a set of antennas.

The UE long term channel sensing manager 1720 may be an example of aspects of the UE long term channel sensing manager 1915 described with reference to FIG. 19.

The UE long term channel sensing manager 1720 and/or at least some of its various sub-components may be implemented in hardware, software executed by a processor, firmware, or any combination thereof. If implemented in software executed by a processor, the functions of the UE long term channel sensing manager 1720 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The UE long term channel sensing manager 1720 and/or at least some of its various sub-components may be physically located at various positions, including being distributed such that portions of functions are implemented at different physical locations by one or more physical devices. In some examples, the UE long term channel sensing manager 1720 and/or at least some of its various sub-components may be a separate and distinct component in accordance with various aspects of the present disclosure. In other examples, the UE long term channel sensing manager 1720 and/or at least some of its various sub-components may be combined with one or more other hardware components, including but not limited to an 110 component, a transceiver, a network server, another computing device, one or more other components described in the present disclosure, or a combination thereof in accordance with various aspects of the present disclosure.

The UE long term channel sensing manager 1720 may receive configuration parameters to support long term channel sensing in a shared spectrum. In some examples, the UE long term channel sensing manager 1720 may control procedures described with reference to FIGS. 10-16.

The transmitter 1730 may transmit signals generated by other components of the device. In some examples, the transmitter 1730 may be collocated with the receiver 1710 in a transceiver module. For example, the transmitter 1730 may be an example of aspects of a transceiver 1935 described with reference to FIG. 19. The transmitter 1730 may utilize a single antenna or a set of antennas.

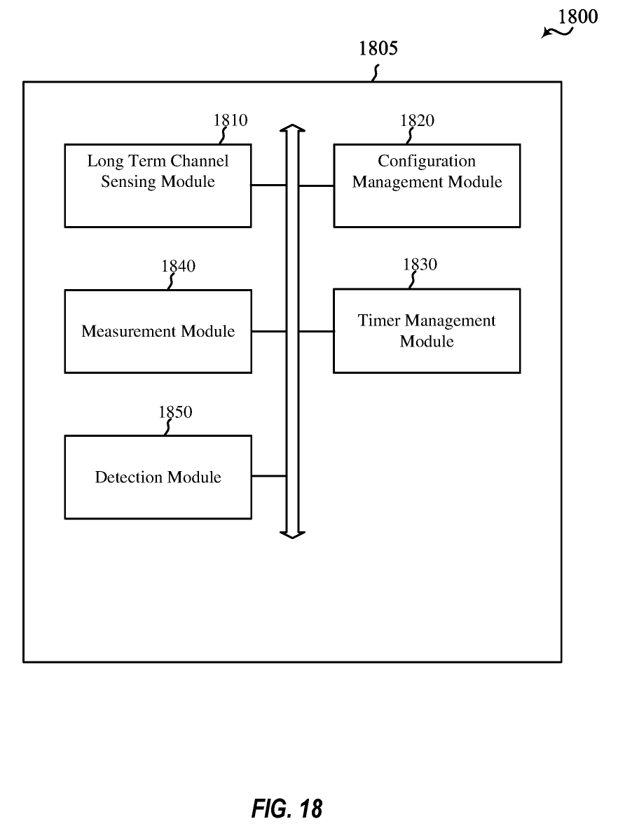

FIG. 18 shows a block diagram 1800 of a wireless device 1805 that supports long term channel sensing in a shared spectrum in accordance with aspects of the present disclosure. The wireless device 1805 may be an example of aspects of the wireless device 1705 or the UE 115 as described herein. The wireless device 1805 may include a long term channel sensing module 1810, configuration management module 1820, timer management module 1830, measurement module 1840, and detection module 1850. The wireless device 1805 may also include a processor. Each of these components may be in communication with one another (e.g., via one or more buses).

The long term channel sensing module 1810 may maintain a configuration for supporting long term channel sensing in a shared spectrum. The configuration may include various examples as described herein.

The configuration management module 1820 may maintain a configuration for supporting long term channel sensing in a shared spectrum. The configuration may include a suspended frozen state of UE prior to the sensing period as described herein.

The timer management module 1830 may receive a configuration for suspending or keeping active a plurality of MAC and RLC timers during a sensing period as described herein.

The measurement module 1840 may receive a configuration for suspending a plurality of measurement related procedures during a sensing period as described herein.

The detection module 1850 may detect transmission of its base station after base station has come back onto the medium after the sensing period as described herein.

FIG. 19 shows a diagram of a system 1900 including a device 1905 that supports long term channel sensing in a shared spectrum in accordance with aspects of the present disclosure. The device 1905 may be an example of or include the components of the UE 115 as described above herein. The device 1905 may include components for bi-directional voice and data communications including components for transmitting and receiving communications, including a UE long term channel sensing manager 1915, processor 1920, memory 1925, software 1930, transceiver 1935, antenna 1940, and I/O controller 1945. These components may be in electronic communication via one or more buses (e.g., bus 1910). The device 1905 may communicate wirelessly with one or more base stations 105.

The processor 1920 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1920 may be configured to operate a memory array using a memory controller. In other cases, a memory controller may be integrated into the processor 1920. The processor 1920 may be configured to execute computer-readable instructions stored in a memory to perform various functions (e.g., functions or tasks supporting long term sensing in the shared spectrum).

The memory 1925 may include RAM and ROM. The memory 1925 may store computer-readable, computer-executable software 1930 including instructions that, when executed, cause the processor to perform various functions described herein. In some cases, the memory 1925 may contain, among other things, a BIOS which may control basic hardware or software operation such as the interaction with peripheral components or devices.

The software 1930 may include code to implement aspects of the present disclosure, including code to support long term sensing in the shared spectrum. The software 1930 may be stored in a non-transitory computer-readable medium such as system memory or other memory. In some cases, the software 1930 may not be directly executable by the processor but may cause a computer (e.g., when compiled and executed) to perform functions described herein.

The transceiver 1935 may communicate bi-directionally, via one or more antennas, wired, or wireless links as described above. For example, the transceiver 1935 may represent a wireless transceiver and may communicate bi-directionally with another wireless transceiver. The transceiver 1935 may also include a modem to modulate the packets and provide the modulated packets to the antennas for transmission, and to demodulate packets received from the antennas.

In some cases, the device 1905 may include a single antenna 1940. However, in some cases the device may have more than one antenna 1940, which may be capable of concurrently transmitting or receiving multiple wireless transmissions.

The I/O controller 1945 may manage input and output signals for the device 1905. The I/O controller 1945 may also manage peripherals not integrated into device 1905. In some cases, the I/O controller 1945 may represent a physical connection or port to an external peripheral. In some cases, the I/O controller 1945 may utilize an operating system such as iOS®, ANDROID®, MS-DOS®, MS-WINDOWS®, OS/2®, UNIX®, LINUX®, or another known operating system. In other cases, the I/O controller 1945 may represent or interact with a modem, a keyboard, a mouse, a touchscreen, or a similar device. In some cases, I/O controller 1945 may be implemented as part of a processor. In some cases, a user may interact with the device 1905 via the I/O controller 1945 or via hardware components controlled by the I/O controller 1945.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of eNBs provide coverage for various geographical regions. For example, each eNB, next generation NodeB (gNB), or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), gNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. It should be noted that the base stations may be deployed by the same operator or different operators. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and TDD system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
configuring a system frame number (SFN) and hyper-SFN associated with a long term sensing pattern; and
transmitting the SFN and hyper-SFN to indicate a sensing period corresponding to the long term sensing pattern.

2. The method of claim 1, further comprising suspending all transmissions during the sensing period.

3. The method of claim 2, further comprising:
determining whether a shared spectrum is available during the sensing period;
resuming, after the sensing period, transmissions on the shared spectrum if it is determined that the shared spectrum is available; and
continue, after the sensing period, suspending all transmissions if it is determined that the shared spectrum is unavailable.

4. The method of claim 1, further comprising configuring whether to suspend a timer during the sensing period, the timer being associated with a user equipment (UE) or a cell.

5. The method of claim 4, wherein the configuring whether to suspend the timer comprises configuring whether to suspend an uplink (UL) timing alignment timer during the sensing period.

6. The method of claim 4, wherein the configuring whether to suspend the timer is based on mobility of the UE.

7. The method of claim 1, further comprising transmitting, after the sensing period, at a power level less than a transmission power level used prior to the sensing period.

8. The method of claim 7, further comprising, prior to transmitting at the reduced power level, at least one of:
transmitting, to at least one UE, a handover command to a different cell;
reconfiguring at least one UE to operate at a reduced power level; or configuring at least one UE to operate in a coverage extension mode.

9. A method for wireless communication, comprising:
receiving a system frame number (SFN) and hyper-SFN associated with a long term sensing pattern;
determining, based on the SFN and hyper-SFN, a sensing period corresponding to the long term sensing pattern; and
suspending a plurality of procedures during the sensing period.

10. The method of claim 9, wherein the suspending the plurality of procedures comprises at least one of:
suspending monitoring all downlink transmissions from a serving base station;
suspending all uplink transmissions to the serving base station;
suspending a plurality of measurement related procedures; or suspending updating a plurality of media access control (MAC) timers and radio resource control (RRC) timers.

11. The method of claim 9, further comprising:
detecting whether a serving base station has acquired a shared spectrum after the sensing period; and
resuming the plurality of procedures after the sensing period when it is detected that the serving base station has acquired the shared spectrum.

12. The method of claim 11, wherein the detecting comprises at least one of:
detecting a physical broadcast channel (PBCH);
detecting a primary synchronization signal/secondary synchronization signal (PSS/SSS);
detecting a cell-specific reference signal (CRS); or
detecting, in a downlink control information, an indication that the serving base station has restarted transmission.

13. The method of claim 11, wherein the resuming the plurality of procedures comprises at least one of:
monitoring a physical downlink control channel (PDCCH) for a downlink assignment or uplink grant;
receiving a physical shared data channel (PDSCH) corresponding to the downlink assignment;
receiving a physical hybrid automatic repeat request channel (PHICH) for an uplink transmission sent prior the sensing period and following a retransmission timeline for the uplink transmission after receiving the PHICH;
transmitting a retransmission on a physical uplink shared channel (PUSCH) according to a PHICH received prior to the sensing period; or
transmitting an ACK/NACK for a downlink transmission received prior to the sensing period.

14. The method of claim 9, further comprising receiving a configuration on whether to suspend an UL timing alignment timer during the sensing period.

15. The method of claim 14, when the UL timing alignment timer has not expired and after the sensing period, further comprising at least one of:
transmitting ACK/NACK for DL transmission received prior the sensing period;
dropping an old channel state information (CSI) report if there is insufficient time to generate a new CSI report before a reporting occasion;
transmitting a physical uplink shared channel (PUSCH) associated with an uplink grant received prior to the sensing period;
transmitting a scheduling request (SR) if uplink data is made available for transmission; or
resuming a plurality of measurement related procedures.

16. The method of claim 9, wherein the suspending the plurality of procedures comprises suspending monitoring for paging messages when in an idle mode.

17. The method of claim 9, when in an idle mode and uplink data is made available for transmission during the sensing period, further comprising:
detecting whether a base station has acquired a shared spectrum after the sensing period;
responsive to detecting that the base station has acquired the shared spectrum, performing random access to connect to the base station; and
transmitting the uplink data according to a first scheduled uplink transmission associated with the random access.

18. The method of claim 9, further comprising, after the sensing period, at least one of:
receiving a handover command to a different cell;
receiving a reconfiguration to operate at a reduced power level; or
receiving a configuration to operate in a coverage extension mode.

19. The method of claim 18, further comprising thereafter, receiving downlink transmissions transmitted at a power level less than a transmission power level used prior to the sensing period.

20. An apparatus for wireless communication, comprising:
a processor;
memory in electronic communication with the processor;
instructions stored in the memory, wherein the instructions are executable by the processor to configure a system frame number (SFN) and hyper-SFN associated with a long term sensing pattern; and
a transmitter configured to transmit the SFN and hyper-SFN to indicate a sensing period corresponding to the long term sensing pattern.

21. The apparatus of claim 20, wherein the instructions are further executable by the processor to suspend all transmissions during the sensing period.

22. The apparatus of claim 21, wherein the instructions are further executable by the processor to:
determine whether a shared spectrum is available during the sensing period;
resume, after the sensing period, transmissions on the shared spectrum if it is determined that the shared spectrum is available; and
continue, after the sensing period, suspending all transmissions if it is determined that the shared spectrum is unavailable.

23. The apparatus of claim 20, wherein the instructions are further executable by the processor to configure whether to suspend a timer during the sensing period, the timer being associated with a user equipment (UE) or a cell.

24. The apparatus of claim 23, wherein the instructions are further executable by the processor to configure at least one of:
whether to suspend an uplink (UL) timing alignment timer during the sensing period; or
whether to suspend the timer based on mobility of the UE.

25. The apparatus of claim 20, wherein the transmitter is further configured to transmit, after the sensing period, at a power level less than a transmission power level used prior to the sensing period.

26. An apparatus for wireless communication, comprising:
a receiver configured to receive a system frame number (SFN) and hyper-SFN associated with a long term sensing pattern;
a processor;
memory in electronic communication with the processor; and
instructions stored in the memory, wherein the instructions are executable by the processor to:
determine, based on the SFN and hyper-SFN, a sensing period corresponding to the long term sensing pattern; and
suspend a plurality of procedures during the sensing period.

27. The apparatus of claim 26, wherein the instructions are further executable by the processor to at least one of:
suspend monitoring all downlink transmissions from a serving base station;
suspend all uplink transmissions to the serving base station;
suspend a plurality of measurement related procedures; or
suspend updating a plurality of media access control (MAC) timers and radio resource control (RRC) timers.

28. The apparatus of claim 26, wherein the instructions are further executable by the processor to:
detect whether a serving base station has acquired a shared spectrum after the sensing period; and
resume the plurality of procedures after the sensing period when it is detected that the serving base station has acquired the shared spectrum.

29. The apparatus of claim 28, wherein the instructions are further executable by the processor to at least one of:
detect a physical broadcast channel (PBCH);
detect a primary synchronization signal/secondary synchronization signal (PSS/SSS);
detect a cell-specific reference signal (CRS); or
detect, in a downlink control information, an indication that the serving base station has restarted transmission.

30. The apparatus of claim 26, wherein the receiver is further configured to receive a configuration on whether to suspend an UL timing alignment timer during the sensing period.
